(19) United States
(12) Patent Application Publication
(10) Pub. No.: US 2013/0292538 A1
(43) Pub. Date: Nov. 7, 2013

(54) ERGONOMIC DEVICE HOLDER

(71) Applicants: Grace Kay DAVIS, Monument, CO (US); Lori Jeaninne Reid, Monument, CO (US)

(72) Inventors: Grace Kay DAVIS, Monument, CO (US); Lori Jeaninne Reid, Monument, CO (US)

(21) Appl. No.: 13/871,634

(22) Filed: Apr. 26, 2013

Related U.S. Application Data
(60) Provisional application No. 61/641,548, filed on May 2, 2012.

(51) Int. Cl. F16M 11/06

(52) U.S. Cl. CPC F16M 11/06
USPC 248/371

(57) ABSTRACT

A personal device holder. The personal device holder can include a body, the body including a first end, a second end, and a curved stem extending between the first end and the second end, and an attachment member pivotably coupled to the second end of the body, the attachment member adapted to couple to a personal device.

### CROSS-REFERENCE TO RELATED APPLICATIONS

This application claims priority to U.S. Provisional Application 61/641,548, filed May 2, 2012 and entitled ERGONOMIC HANDLE AND STAND, the entire contents of which are hereby incorporated by reference.

### BACKGROUND

Personal devices such as tablet computers, electronic readers, and clipboards are often designed to be held with one hand and operated with the other. This requires the hands to be held at unnatural and inconvenient angles, and subjects the arms to stress. Over time, this style of use can lead to fatigue, discomfort, and soreness.

Furthermore, many personal devices have a flat configuration. The flat configuration can result in discomfort for the user, as the device can be too thin to be gripped comfortably. The flat configuration can also result in the device easily slipping out of the hands of the user.

Accordingly, a solution for comfortably holding a personal device is desired.

### SUMMARY

According to at least one exemplary embodiment, a personal device holder is disclosed. The personal device holder can include a body, the body including a first end, a second end, and a curved stem extending between the first end and the second end, and an attachment member pivotably coupled to the second end of the body, the attachment member adapted to couple to a personal device.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a side elevational view of an exemplary embodiment of an ergonomic device holder.

FIG. 2 is a front elevational view of an exemplary embodiment of an ergonomic device holder.

FIGS. 3-4 are cross-sectional views of an exemplary embodiment of an ergonomic device holder.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

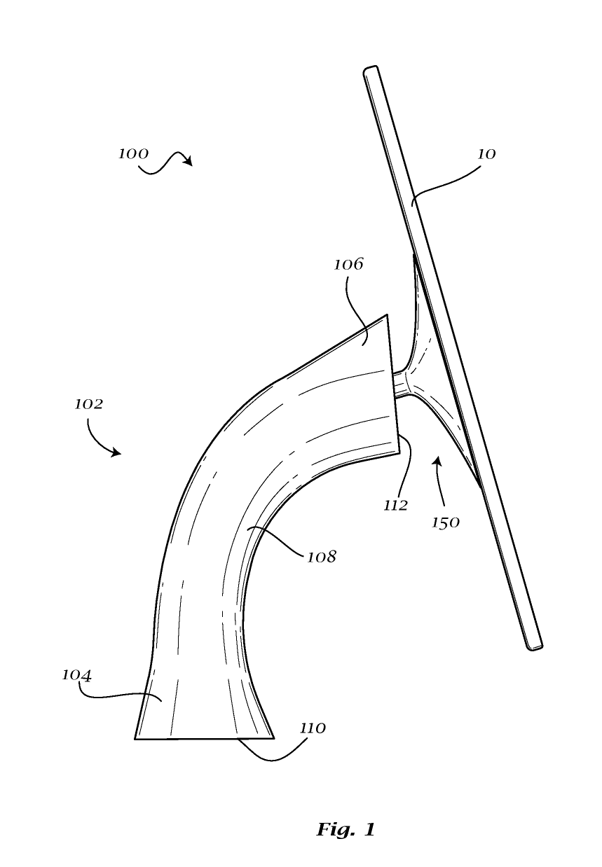

Generally referring to FIGS. 1-4, an ergonomic device holder may be described. The handle and stand can attach to a device, such as a tablet computer or clipboard, and can assist in holding, supporting, and using the device in the hand or otherwise.

Turning to FIG. 1, an ergonomic device holder 100 can provide a convenient manner or mechanism for supporting a device. In some exemplary embodiments, device 10 can be an electronic device such as a tablet computer, laptop computer, electronic reader, electronic map, Global Positioning System device, signaling device, lamp, flashlight, sensor device, camera, sound recorder, cellular telephone, smartphone, music player, video player, photograph viewer, or any other type of electronic device as desired. In some exemplary embodiments, device 10 can be any other type of device, such as a clipboard, writing pad, drawing pad, picture frame, or any other device or type of device as desired. Ergonomic handle and stand 100 can be adapted to attach to device 10 and allow a user to conveniently support, carry, hold, or otherwise interact with device 10 in any orientation or position as desired.

The ergonomic device holder 100 can include a body 102 and an attachment member 150. Body 102 may have a substantially tubular configuration, and may include a first end 104, a second end 106, and a stem 108, which may all be integrally formed. First end 104 can include a first planar face 110 and second end 106 can include a second planar face 112, both of which may be substantially flat.

Body 102 may be curved such that the planes of first face 110 and second face 112 are disposed at an oblique angle to each other. In some exemplary embodiments, the angle between first face 110 and second face 112 may be in the range of approximately 75°-110°, for example about 85° or about 90°.

Body 102 may further be flared such that the diameter of first end 104 and the diameter of second end 106 are greater than the diameter of stem 108. This can allow the user to comfortably and securely grip body 102, as the sizes of the diameter and curvature radius of stem 108 can facilitate providing a comfortable grip, while the curvature of stem 108 as well as flared ends 104, 106 can reduce the likelihood of body 102 slipping through the user's hand while the user is holding the ergonomic handle and stand 100.

Body 102 can be made of any desired material or combination of materials, for example hard or soft rubbers, metals, or plastics. Furthermore, body 102 can have any desired texture or combination of textures, for example smooth, rough, or tacky. In some exemplary embodiments, body 102 can be adapted to be attached to a surface, for example by provision of an adhesive or tacky material on first face 110, by provision of a magnet within first end 104, by a suction cup coupled thereto, or by any other known fastener or manner of fastening. Additionally, in some exemplary embodiments, first end 104 may be weighted, for example by provision therein of a weight or other material having a density greater than the material from which body 102 is formed. The weighted configuration of first end 104 can facilitate positioning device holder 100 upright on a substantially horizontal surface. The weighted configuration of first end 104 can further act a counterweight to the device 10 disposed proximate second end 106, thereby further facilitating ease of holding device holder 100 by the user.

In an exemplary embodiment, body 102 may have a height in the range of about 5.5 to 6.5 inches, for example 6.1 inches. Body 102 may have a length of about 3.25 to 4.25 inches, for example 3.75 inches. The diameters of ends 104, 106 may be between 1.75 and 2.25 inches, for example 2.0 inches, while the diameter of stem 108 may be between 1.0 and 1.5 inches, for example 1.25 inches. However, it should be understood that any other dimensions for body 102 may be contemplated and provided as desired without departing from the spirit of the embodiments disclosed herein.

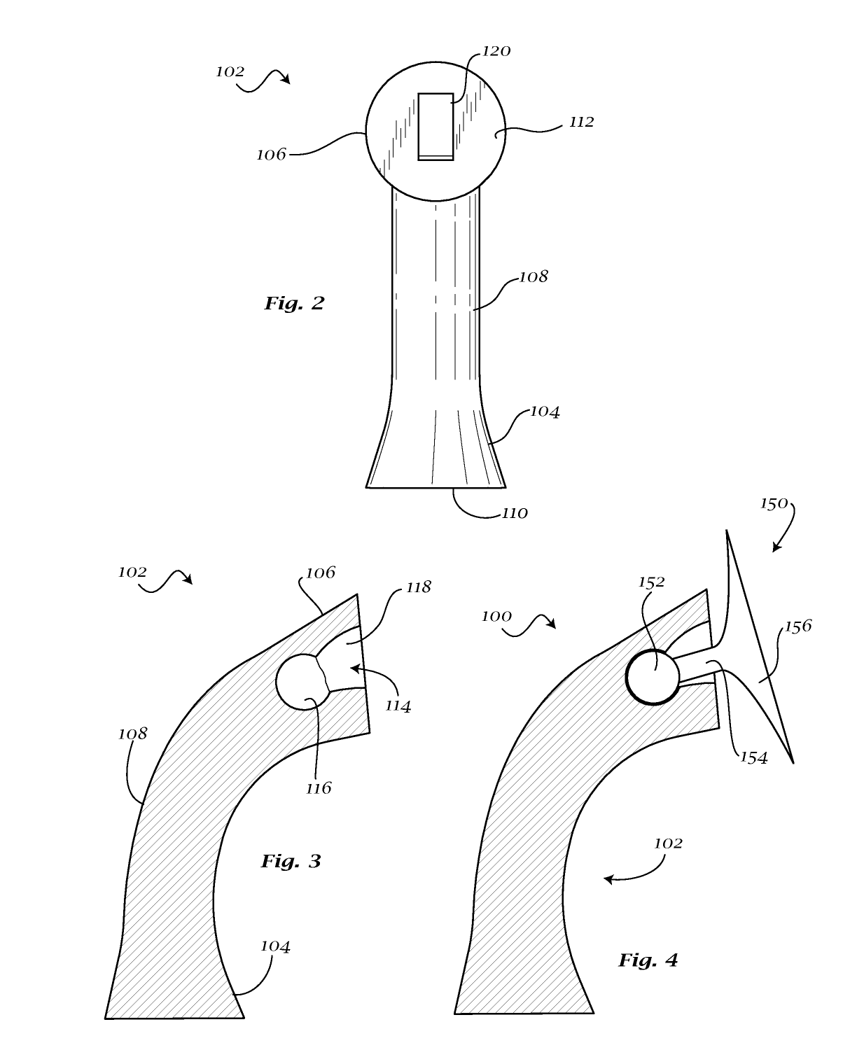

Turning to FIGS. 2-3, second end 106 may have a socket 114 defined therein. Socket 114 can include a cavity 116 and a passage 118 extending between cavity 116 and second face 112. Cavity 116 may be substantially spherical, hemispherical, or may have any shape that enables the device holder 100 to function as described herein. Passage 118 may terminate in an opening 120 at second face 112. The height of passage 118 may increase with proximity to opening 120. In the illustrated embodiment, the upper and lower walls of passage 118 may further have a curvilinear shape; however, in other exemplary embodiments, the upper and lower walls of passage 118 may be linear.

As shown in FIGS. 1 and 4, device holder 100 can also include an attachment member 150. In some exemplary embodiments, attachment member 150 may be pivotably coupled to device holder 100. In further exemplary embodiments, attachment member 150 may also be removably coupled to device holder 100.

Attachment member 150 can include an insert portion 152, a stem 154, and a coupling structure 156. In some exemplary embodiments, coupling structure 156 may be a suction cup. In still other exemplary embodiments, coupling structure 156 can include an adhesive, such as a pressure-sensitive adhesive or a temperature-sensitive adhesive disposed on a substantially planar face of the coupling structure.

Attachment member 150 may be formed from any material that enables device holder 100 to function as described herein. In some exemplary embodiments, attachment member 150 may be formed integrally; in other exemplary embodiments, the various components of attachment member 150 may be coupled to each other by any fastener or manner of attachment that enables device holder 100 to function as described herein. Furthermore, in some exemplary embodiments, portions or the entirety of attachment member 150 may be formed from a resiliently deformable material, such as rubber, polymer or any other desired material.

Insert portion 152 may be sized and shaped to be received within cavity 116 of socket 114 of body 102. Furthermore, insert portion 152 may be sized and shaped to allow attachment member 150 to pivot with respect to body 102. In the illustrated embodiment, insert portion 152 may be substantially spherical, similar to the shape of cavity 116. Furthermore, insert portion 152 may be sized so as to allow insert portion 152 to engage the surface of cavity 116. This can allow for sufficient frictional engagement between insert portion 152 and cavity 116 so as to maintain a desired orientation of attachment member 150 in relation to body 102, including when attachment member 150 is coupled to a device 10. However, the frictional engagement between insert portion 152 and cavity 116 may be such that the user may be able to change the orientation of attachment member 150 by applying a sufficient amount of force thereto, for example by holding body 102 in one hand and applying force to attachment member 150 or to device 10 with the other hand.

In some exemplary embodiments, passage 118 may be sized so as to allow insert portion 152 to pass therethrough and into cavity 116; however, passage 118 may be sufficiently narrow that an application of force is required to insert and to withdraw insert portion 152 to and from cavity 116. In yet other exemplary embodiments, insert portion 152 may be pivotably but not removably disposed within cavity 116.

In an exemplary embodiment, cavity 116 may have a diameter of between approximately 0.70 inches and approximately 0.90 inches, for example about 0.80 inches. As discussed above, the diameter of insert portion 152 may be substantially similar. Furthermore, in the exemplary embodiment, the height of passage 118 proximate cavity 116 may be between approximately 0.45 inches and approximately 0.65 inches, for example about 0.54 inches. Additionally, the height of passage 118 proximate opening 120 may be between approximately 0.80 inches and approximately 1.00 inches, for example about 0.89 inches. The width of passage 118 may be may be between approximately 0.40 inches and approximately 0.60 inches, for example about 0.50 inches.

The stem 154 of attachment member 150 may have any desired width and length that enable device holder 100 to function as described herein. Stem 154 may further have a cross-section that is cylindrical, rectangular, or any other shape. Stem 154 may be sized so as to allow stem 154 to move in a vertical direction within passage 118, thereby facilitating pivoting attachment member 150 with respect to body 102. In some exemplary embodiments, stem 154 may be sized to further allow movement in horizontal and diagonal directions within passage 118, further facilitating pivoting attachment member 150 with respect to body 102.

While in some exemplary embodiments, attachment member 150 may be formed integrally, in other exemplary embodiments, the attachment member may be formed from separate parts that may be fixedly or detachably coupled to each other. For example, the coupling portion 156 may be fastened to device 10, and may be detachably coupled from stem 154 by any known fastener or manner of coupling. This can allow device 10 and coupling portion 156 to be detached from device holder 100, while the insert portion and stem of attachment member 150 remain coupled to body 102. and a non-detachable portion which can remain on ergonomic handle and stand 100.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An ergonomic device holder, comprising:
a body, the body including a first end, a second end, and a curved stem extending between the first end and the second end; and
an attachment member pivotably coupled to the second end of the body, the attachment member adapted to couple to a personal device.

2. The device holder of claim 1, further comprising:
a socket defined within the body for receiving a portion of the attachment member, the socket being disposed at the second end of the body.

3. The device holder of claim 1, the attachment member comprising:
an insert portion receivable within a socket defined in the body; and
a coupling portion adapted to couple to the personal device.

4. The device holder of claim 3, wherein the insert portion is formed from a resiliently deformable material.

5. The device holder of claim 3, wherein the coupling portion comprises a suction cup.

6. The device holder of claim 3, wherein the coupling portion is detachable from the insert portion.

7. The device holder of claim 1, the socket comprising:
a cavity disposed within the body; and
a passage extending between the cavity and a face of the second end.

8. The device holder of claim 7, wherein the attachment member includes an insert portion receivable within the cavity, the insert portion and the cavity being sized so as to create a friction fit therebetween.

9. The device holder of claim 1, wherein the first end is weighted.

10. The device holder of claim 1, wherein the diameter of the stem is less than the diameter of the first end.

11. The device holder of claim 1, wherein the diameter of the stem is less than the diameter of the second end.
